(19) United States
(12) Patent Application Publication
(10) Pub. No.: US 2009/0280689 A1
(43) Pub. Date: Nov. 12, 2009

(54) ELECTRICAL CONTACT WITH X-Y OFFSETS

(75) Inventors: CHUN-FU LIN, Tu-Cheng (TW); HSIU-YUAN HSU, Tu-Cheng (TW); JIA-HAU LIU, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/464,032

(22) Filed: May 11, 2009

(30) Foreign Application Priority Data
May 12, 2008 (TW) 97117367

(51) Int. Cl. H01R 13/46; H01R 13/02

(52) U.S. Cl. 439/625; 439/884

(57) ABSTRACT

An electrical contact (1) includes an upper extending portion (11), a lower extending portion (12) and a bridge portion (13). The upper extending portion includes a first contact portion (111), a C-shaped connecting portion (1121) connecting with the first contact portion and a tail portion (1122) extending downwardly from a free end of the C-shaped connecting portion. The lower extending portion includes a second contact portion (121), a vertical portion (1222) and an inclined portion (1221) connecting with the second contact portion and the vertical portion. The bridge portion is integrally formed between the tail portion and the vertical portion. One of the upper extending portion and the lower extending portion rotates around the bridge portion.

### BACKGROUND OF THE INVENTION

1. Field of the Invention

The present invention relates generally to electrical contacts, and more particularly to an electrical contact with X-Y offsets for connecting a central processing unit (CPU) with a printed circuit board (PCB).

2. Description of Related Arts

An electrical connector connects the CPU with the PCB for transmitting signals therebeween and is used more and more frequently according to popularization of the electric products such as computers. Electrical contacts comprise Pin Grid Array (PGA) contacts, Ball Grid Array (BGA) contacts and Land Grid Array (LGA) contacts, and accordingly, electrical connectors comprising said kinds of contacts are divided into PGA connectors, BGA connectors and LGA connectors.

An LGA contact comprises a first cantilever am with a first contact portion at a free end thereof for connecting with the CPU, a second cantilever arm with a second contact portion at a free end thereof for connecting with the PCB and a connection portion combining the first and second cantilever arms. The contact has a generally C-shaped profile and in detail, the first cantilever arm extends upwardly and forwardly from the upper section of the connection portion and the second cantilever arm extends downwardly and forwardly from the lower section of the connection portion. As a result, the first contact portion and the second contact portion echo each other along a vertical line. Such kind of contact is limited in a useable condition that the CPU and the PCB must be acquired to be in a vertical line. The contact does not suit for the multiplicity of the CPU according to a very fast development of the electrical technology.

An improved electrical contact comprises a center torsion beam, two engagement plates integrally connected to two ends of the center torsion beam and two spring arms extending oppositely from a center section of the torsion beam, with one extending upwardly and forwardly while the other one extending downwardly and backwardly. The contacting portions of the contact respectively abut against the contact pads both of the CPU and the PCB and because the contacting portions are not positioned along a vertical direction, the connected CPU and the connected PCB are located with X-Y offset. Such kind of contact provides a special X-Y offset, though it can provide diversified X-Y offsets by adjusting angles in the housing. The method said above is rather troublesome for the mating housing should be molded again to mate with the engagement plates of the contact.

Hence, an improved electrical contact with adjustable X-Y offsets is desired.

### SUMMARY OF THE INVENTION

Accordingly, an object of the present invention is to provide an electrical contact with adjust X-Y offsets to suit for different acquires of different customers.

To achieve the above object, an electrical contact includes an upper extending portion, a lower extending portion and a bridge portion. The upper extending portion includes a first contact portion, a C-shaped connecting portion connecting with the first contact portion and a tail portion extending downwardly from a free end of the C-shaped connecting portion. The lower extending portion includes a second contact portion, a vertical portion and an inclined portion connecting with the second contact portion and the vertical portion. The bridge portion is integrally formed between the tail portion and the vertical portion. One of the upper extending portion and the lower extending portion rotates around the bridge portion.

Other objects, advantages and novel features of the invention will become more apparent from the following detailed description when taken in conjunction with the accompanying drawings.

### BRIEF DESCRIPTION OF THE DRAWING

FIG. 1 is a perspective view of an electrical contact according to the present invention;

FIG. 2 is a left side view of the electrical contact;

FIG. 3 is a rear elevational view of the electrical contact; and

FIG. 4 is a top plan view of the electrical contact.

### DETAILED DESCRIPTION OF THE PREFERRED EMBODIMENT

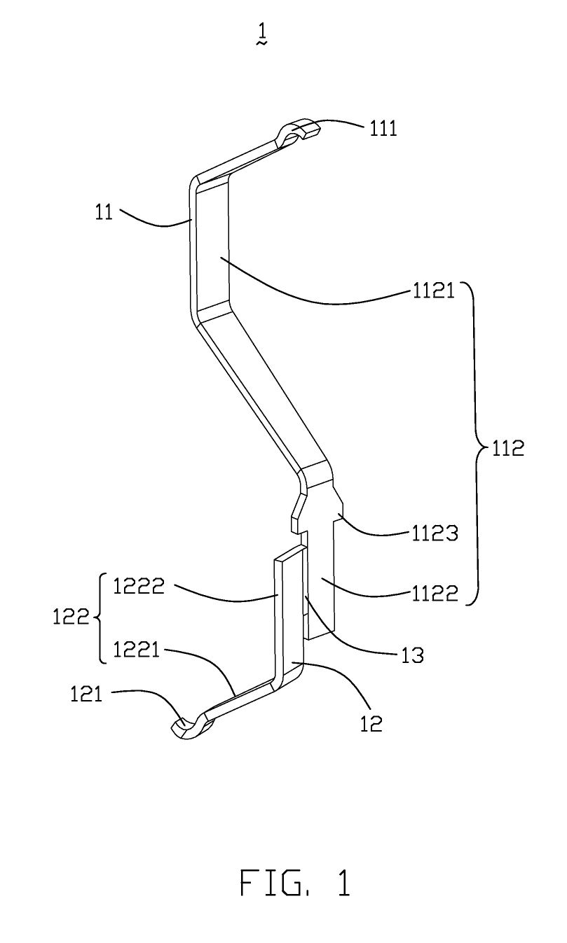

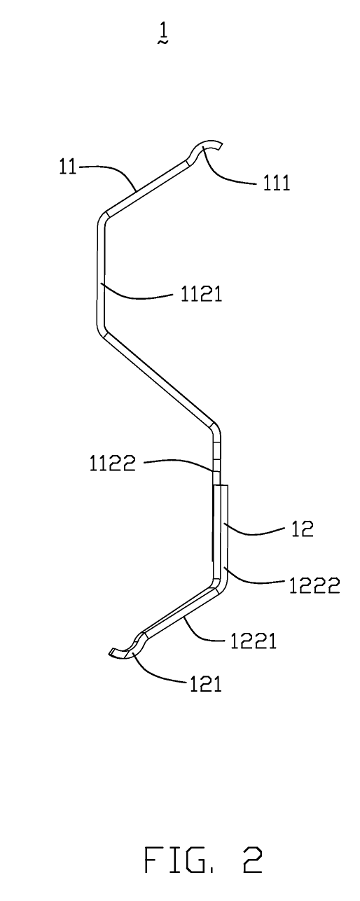

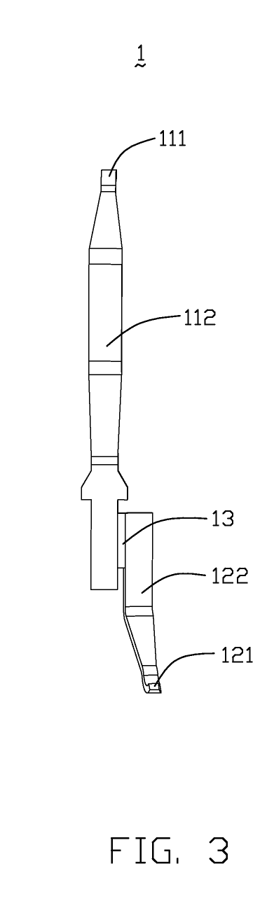

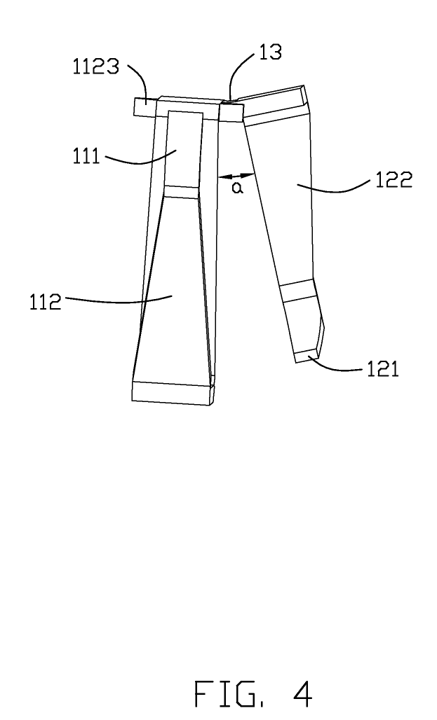

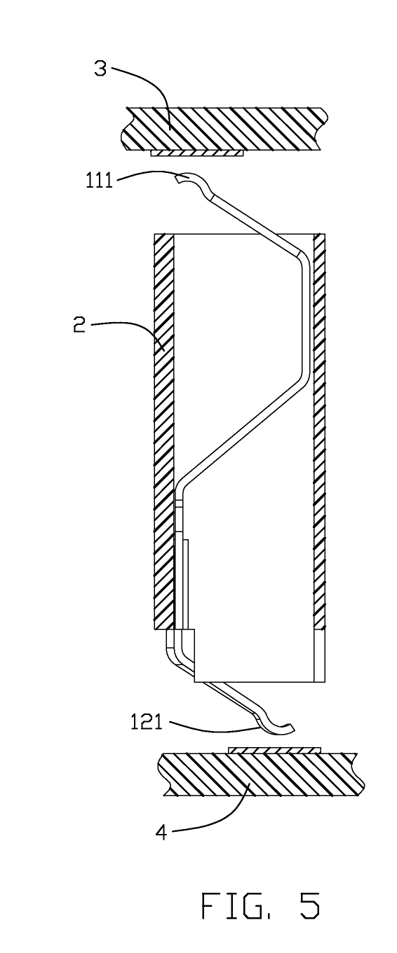

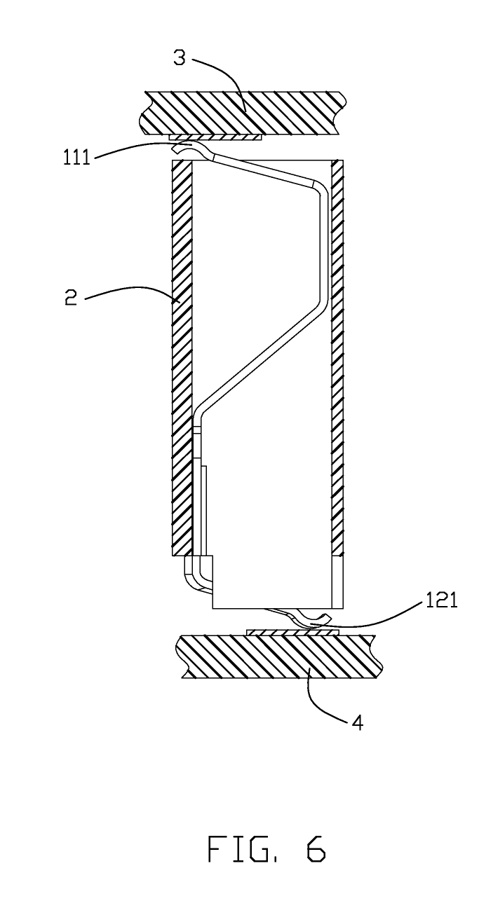

FIGS. 1-4 illustrate an electrical contact 1 in accordance with the present invention, used for connecting a central processing unit (CPU) (not shown) with a printed circuit board (PCB) (not shown) to transmitting signals therebetween. The electrical contact 1 integrally comprises an upper extending portion 11, a lower extending portion 12 and a bridge portion 13 connecting the upper extending portion 11 with the lower extending portion 12. The upper extending portion 11 comprises a first contact portion 111 connecting with the CPU and a first spring arm 112. The first spring arm 112 comprises a C-shaped connecting portion 1121 and a tail portion 1122 extending downwardly from a free end of the C-shaped connecting portion 1121. The tail portion 1122 forms a plurality of fastening portions 1123 for retaining the electrical contact 1 in a housing (not shown). The lower extending portion 12 comprises a second contact portion 121 connecting with the PCB and a second spring arm 122. The second spring arm 122 comprises a vertical portion 1222 and an inclined portion 1221 connecting with the vertical portion 1222 and the second contact portion 121. The tail portion 1122 and the vertical portion 1222 are both connected to the bridge portion 13 to communicate with each other. The first contact portion 111 and the second contact portion 121 are both curved and extend oppositely. In this embodiment, the fastening portions 1123 are formed on the tail portion 1122 of the upper extending portion 11; in an alternative embodiment, a plurality of fastening portions formed on the vertical portion 1222 of the lower extending portion 12 is feasible. In a general view, the electrical contact 1 has an S-shaped configuration.

In fabrication, first, a metal sheet is stricken out by a punch to be an embryo electrical contact 1 with the upper extending portion 11 and the lower extending portion 12 both connected to the bridge portion 13, while the upper extending portion 11 and the lower extending portion 12 extend oppositely. The upper extending portion 11, the lower extending portion 12 and the bridge portion 13 are in a same plane. Secondly, the electrical contact 1 is pressed to be an S-shaped figure with a C-shaped connecting portion 1121 formed on the upper extending portion 11 and an inclined portion 1221 formed on the lower extending portion 12. The inclined portion 1221 extends along a direction opposite to a direction which is defined by an opening of the C-shaped connecting portion 1121. At this time, the tail portion 1122 of the upper extending portion 11 and the vertical portion 1222 of the lower extending portion 12 remain in a same plane. Finally, an angle “a” is formed between the tail portion 1122 and the vertical portion 1222 by bending the bridge portion 13 according to the different arrangements of the CPU and the PCB, so, an adjust X-Y offset is generated on the electrical contact 1 and the electrical contact 1 can be effectively connected to the CPU and the PCB having different arrangements. When the electrical contact 1 is inserted into a housing (not shown), one of the upper extending portion 11 and the lower extending portion 12, which has the fastening portions 1123, is engaged with the housing, while the other one rotates around the bridge portion 13 for providing adjustable X-Y offsets. This invention provides a cost down because of no need to replace the housing.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical contact comprising:
an upper extending portion comprising a first contact portion, a C-shaped connecting portion connecting with the first contact portion and a tail portion extending downwardly from the C-shaped connecting portion;
a lower extending portion comprising a second contact portion, a vertical portion and an inclined portion connecting with the second contact portion and the vertical portion; and
a bridge portion integrally formed between the tail portion and the vertical portion; wherein
one of the upper extending portion and the lower extending portion rotates around the bridge portion.

2. The electrical contact as described in claim 1, wherein the contact has a generally S-shaped figure.

3. The electrical contact as described in claim 2, wherein the inclined portion extends along a direction opposite to a direction which is defined by an opening of the C-shaped connecting portion.

4. The electrical contact as described in claim 3, wherein the contact portions are curved.

5. The electrical contact as described in claim 4, wherein the first contact portion connects with a CPU.

6. The electrical contact as described in claim 4, wherein the second contact portion connects with a PCB.

7. The electrical contact as described in claim 3, further comprising a plurality of fastening portions formed on the tail portion.

8. The electrical contact as described in claim 3, further comprising a plurality of fastening portions formed on the vertical portion.

9. An electrical connector comprising:
an insulative housing defining at least one passageway;
a contact disposed in the passageway and including:
an upward extending and downward deflectable resilient contact section essentially located in a first vertical plane in a top view;
a downward extending and upward deflectable resilient tail section essentially located in a second vertical plane beside said first plane in said top view;
said upward extending contact section and said downward extending tail section linked to each other via a transverse bridge portion.

10. The electrical contact as claimed in claim 9, wherein said bridge portion is located around a lower portion of the upward extending contact section.

11. The electrical contact as claimed in claim 9, wherein said upward extending contact section is further equipped with a retention section around a lower portion thereof.

12. The electrical contact as claimed in claim 11, wherein said bridge portion is lower than said retention section.

13. The electrical connector as claimed in claim 9, wherein said first plane is angled with said second plane.

14. The electrical connector as claimed in claim 9, wherein said upward extending contact section defines an upper engagement end region for engagement with an upper electronic part, and said downward extending tail section defines a lower engagement end region for engagement with the lower electronic part under condition that deflection of said upper engagement end region is spanned in a downward direction and a first transverse direction, and that of said lower engagement end region is spanned in a vertical direction opposite to said downward direction, and a second transverse direction which is not same with said first transverse direction.

15. The electrical connector as claimed in claim 14, wherein said first transverse is angled with said second transverse direction.

16. The electrical connector as claimed in claim 9, wherein said upward extending contact section extends initially from a first inner wall of the corresponding passageway to a second inner wall of the corresponding passageway opposite to said first inner wall and successively from said second inner wall back to said first inner wall.

17. An electrical connector comprising:
an insulative housing defining at least one passageway extending through both upper and lower surfaces thereof;
a contact disposed in the passageway and including:
an upper downward deflectable resilient contact segment upwardly extending above the upper surface in a first direction in a top view, and a lower upwardly deflectable resilient tail segment downward extending below the lower surface in a second direction in said top view; wherein
said first direction and said second direction defines an obtuse angle therebewteen.

18. The electrical connector as claimed in claim 17, wherein a retention section of said contact is closer to the lower tail segment than the upper contact segment.

19. The electrical connector as claimed in claim 18, wherein said upper contact segment is derived from an upward extending resilient contact portion, and the lower tail segment is derived from a downward extending resilient tail portion which is shorter than the upward extending contact portion.
